(19) United States
(12) Patent Application Publication
(10) Pub. No.: US 2025/0369482 A1
(43) Pub. Date: Dec. 4, 2025

(54) MANUFACTURING METHOD OF A COMPOSITE MATERIAL ROLLING BEARING CAGE, ROLLING BEARING CAGE AND ASSOCIATED ROLLING BEARING UNIT

(71) Applicants: AKTIEBOLAGET SKF, GOTEBORG (SE); SKF Aerospace France S.A.S, Perrigny (FR)

(72) Inventors: Thomas Bernd KRAUSE, Grafenrheinfeld (DE); Hari Shankar VADIVEL, Nieuwegein (NL); Anthony Roger Jeannot JÉRÔME, Valence (FR); Florian Vincent BARDY, Perrigny (FR)

(21) Appl. No.: 19/211,383

(22) Filed: May 19, 2025

(30) Foreign Application Priority Data
May 29, 2024 (IT) 102024000012289

(51) Int. Cl. F16C 33/46; B29C 70/16

(52) U.S. Cl. CPC F16C 33/4635; B29C 70/16; F16C 2208/82

(57) ABSTRACT

A method for producing a composite material rolling bearing cage includes: a) winding around a mandrel a plurality of layers of reinforcing fiber impregnated with or embedded in a synthetic resin material to form a preform tube on the mandrel, b) after step a), wrapping, without radial play and under tension, a shrink tape around the radially outermost layer of reinforcing fiber of the preform tube, c) after step b, without removing the shrink tape, inserting the mandrel and preform tube into an oven and curing the preform tube on the mandrel to polymerize the synthetic resin to form a synthetic plastic matrix in which the reinforcing fibers are embedded. Also d) radially cutting a plurality of axial segments from the preform tube and e) providing a plurality of radial through openings in each of the plurality of axial segments.

### CROSS-REFERENCE

This application claims priority to Italian patent application no. 102024000012289 filed on May 29, 2024, the contents of which are fully incorporated herein by reference.

### TECHNOLOGICAL FIELD

The present disclosure relates to a manufacturing method of a rolling bearing cage formed from a fiber reinforced composite synthetic plastic material, as well as to a rolling bearing cage manufactured according to the method and to an associated rolling bearing unit including such a cage. The disclosure relates, in particular, to an improved manufacturing method that allow a fiber reinforced composite synthetic plastic material cage to be obtained with high dimensional precision, so as to limit to a minimum the machining necessary to obtain the final cage.

### BACKGROUND

As it is well known, a rolling bearing unit comprises a rolling bearing having an outer ring, an inner ring and a plurality of rolling bodies (for example balls) interposed between the inner and outer rings to make them relatively rotatable with low friction, and a rolling bearing cage to retain in position the rolling bodies, the cage being arranged in the radial space delimited between the inner ring and the outer ring.

A rolling bearing retaining cage comprises an annular body delimited between radially inner and an outer cylindrical surface and a plurality of pockets or seats, each configured to house and retain in a freely rotatable manner a respective rolling body of the rolling bearing. The cage body is generally made of a synthetic plastic material, for example a phenolic resin or a polyamide or other suitable synthetic materials, and has the pockets or seats, which are provided radially therethrough, e.g. in the form of radial through openings.

A preferred manufacturing method involves obtaining a preform in the shape of a hollow tube, e.g., by molding the synthetic material, then cutting the hollow tube radially into a plurality of slices, each slice constituting a cage body. Before or after the cutting operation the pockets or seats are drilled through the cage body.

To improve the operative performance of the cage, is also known to form the cage body from a fiber-reinforced synthetic material, e.g. phenolic resins reinforced with cotton fibers embedded in the synthetic material matrix, or any other suitable composite material. In these cases, the hollow tube constituting the preform may be produced by any known process of fiber placement or by a process known as “continuous filament winding”, by tightly winding on a metal mandrel tool one or more filaments of composite material in the form of continuous fibers impregnated with a synthetic plastic resin.

Here and in the following, for “plastic resin” it is to be understood either a thermoset or thermoplastic synthetic material, e.g., impregnation of fibers can either be made by a liquid thermoset resin or by a solid thermoplastic powder.

After a prefixed number of superimposed radial layers of pre-impregnated fibers are obtained, the preform is cured in a known manner to cause the consolidation of the synthetic material impregnating the fibers in a solid matrix, in which the winded fibers remain embedded to constitute a reinforcing material. Curing may occur as disclosed, e.g., in FR 3053624 A1.

Other methods of fiber placement may be used to obtain the preform tube, e.g., by superimposing on one another layers of pre-impregnated fiber (pre-peg) in form of sheets or mats having the pre-impregnated reinforcing fibers thereof neatly arranged according to prefixed patterns.

In any case, irrespective the obtention method thereof, but anyway more frequently when CFW manufacturing methods are employed, fiber reinforced plastic cages may require an intense machining following the formation of the preform tube to bring the dimension of the cage withing the prescribed working tolerances. In particular, when a CFW method is used to form the preform tube, the outer and inner diameter of the preform tube, or those of the resulting cages radially cut therefrom, often must be subjected to a turning or grinding process.

In fact, composite tubes produced by conventional standard filament winding or fiber placement processes show wavy undulated tube surfaces, which are not able to directly fulfil the narrow tolerances for the inner and outer diameters of the bearing cages. Consequently, the semi-finished tubes, namely the preform tubes, are produced with a thickness greater than the nominal one (i.e. that one assigned in the design step) and additional turning and/or grinding processes are needed to achieve the correct bearing cage inner and outer diameter within requested tolerances.

### SUMMARY

Accordingly, there is the need in the art to produce fiber reinforced preform tubes with smooth radially inner and outer surfaces and having already the correct inner and outer diameters designed for the final rolling bearing cage. In fact, the need of machining the preform tube (or the cages preform obtained therefrom) increases the production costs, not only due to the machining operation per se, but also, and above all, for the greater use of valuable raw materials involved, which may be expensive, and for a higher energy consumption in the curing step, due to the larger quantity of material to be treated. Moreover, repeated machining may introduce errors that may bring to scraps.

An aspect of the present disclosure is to overcome the drawbacks of the prior art by providing a manufacturing method of a composite material rolling bearing cage made of a fiber reinforced synthetic plastic material, that substantially avoids the need for machining the outer and inner diameter of the preform tube or/and of the cage in order to reach the design diameters and staying within the required working tolerances.

It is also an aspect of the disclosure to provide a manufacturing method which requires lower quantities of raw materials and reduces energy consumption.

It is finally an aspect of the disclosure to provide a composite material rolling bearing cage made of a fiber reinforced synthetic plastic material having reduced production costs and a high precision rolling bearing unit equipped with such a cage, at the same time maintaining good performances in use, especially in particularly stressful applications, like those requiring high rotation speeds and/or subjected to high loads.

The present disclosure allows composite preform tubes configured for production of rolling bearing cages by means of any of the methods known in the art and having a correct dimension of the final inner and outer diameter of the cage to be obtained at the time of fiber placement during the filament winding processes.

In embodiments of the disclosure, a defined number of layers of composite material are wound with controlled tension onto a smooth metal mandrel/tool having its outer diameter identical to the required inner diameter of the cage to be produced. The fiber placement or filament winding process is stopped when the required cage outer diameter is achieved at the top of the stack of superimposed fiber layers impregnated with a suitable polymer resin, wound on the mandrel to form a tube.

In a second step, a commercial shrink tape is placed or wound under controlled tension onto the outer surface of such tube formed by the stacked layers of polymer impregnated fibers, which fibers have been oriented in the preceding step in each layer according to a predetermined pattern.

In a third step, the metallic mandrel/tool, still carrying the tube of superimposed layers of polymer impregnated fibers wound thereupon, is placed, together with the layers of impregnated fibers and the shrink tape wound around the radially outermost layer of impregnated fibers into an oven and cured under defined temperature and time, e.g., according to FR 3053624 A1.

During the curing step, the shrinkage of the shrink tape due to the increase of temperature leads to a defined smoothing and compression/compaction of the composite preform tube made of superimposed layers of polymer impregnated fibers producing, after curing and after having extracted the metallic mandrel/mandrel from the cured preform tube, and after cutting in radial direction the cured preform tube freed from the mandrel in slices, a number of cages, all having the required and the same cage outer diameter established in the design stage.

Consequently, any additional grinding or turning processes of the composite cured preform tube to achieve the required inner and outer bearing cage diameters within requested tolerances can be eliminated or at least strongly reduced, which leads to material and manufacturing time reduction as well as carbon footprint and cost savings.

### BRIEF DESCRIPTION OF THE DRAWINGS

Further characteristics and advantages of the present disclosure will become clear from the following description of non-limiting examples thereof, carried out with reference to the Figures of the attached drawings, in which:

FIG. 1 is a side elevational view, partly in section, of a rolling bearing unit having a rolling body retaining cage made according to an embodiment of the disclosure.

FIG. 2 is a perspective view of the retaining cage of FIG. 1.

FIG. 3 is a schematic illustration of a method of forming a preform tube for obtaining the retaining cage of FIG. 2.

FIG. 4 is a perspective view of a portion of the preform tube of FIG. 3, some layers of which have been removed for illustration purpose.

### DETAILED DESCRIPTION

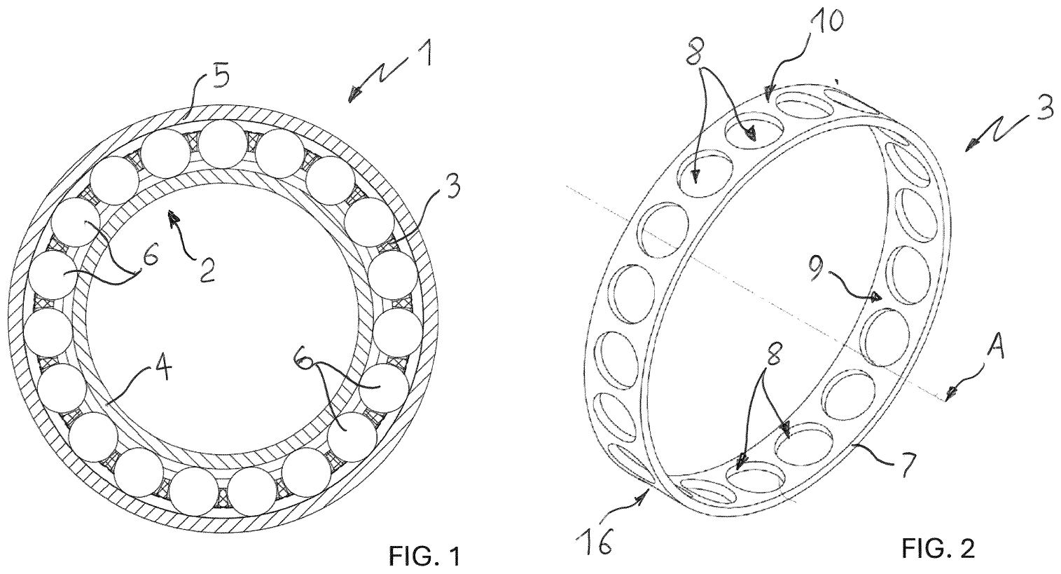

With reference to FIGS. from 1 to 4, the reference number 1 indicates a rolling bearing unit (FIG. 1) comprising a rolling bearing 2 of any known type and a rolling bearing cage 3 made of a composite material. The rolling bearing comprises an inner ring 4, an outer ring 5 and a plurality of rolling elements or bodies 6, in the non-limiting embodiment shown comprising balls. The rolling bodies 6 are arranged, in the example shown, in one row of balls around an axis of symmetry of the rolling bearing, which is also the axis of symmetry A of cage 3 (FIG. 2). In different embodiments, not shown for sake of simplicity, the rolling bearing 2 may comprise two rows of rolling bodies arranged side by side, and the rolling bodies may be without limitation, balls, cylindrical or conical rolls, small cylinders, according to the operation necessity.

In any case, the rolling bearing cage 3 (FIG. 2) comprises an annular body 7 and a plurality of pockets or seats 8, each configured to freely house in use a respective rolling body 6 of the rolling bearing 2 to correctly keep the rolling bodies 6 spaced apart to each other by a prefixed pitch. The annular body 7 has an axis of symmetry A and a prefixed axial width or length. The pockets or seats 8 extend radially throughout the annular body 7, through respective radially inner and outer cylindrical surfaces 9 and 10 (FIG. 2) of the annular body 7, substantially perpendicularly thereto and, in the example shown, are simple cylindrical radial holes. The surfaces 9 and 10 radially delimit the annular body 7 therebetween.

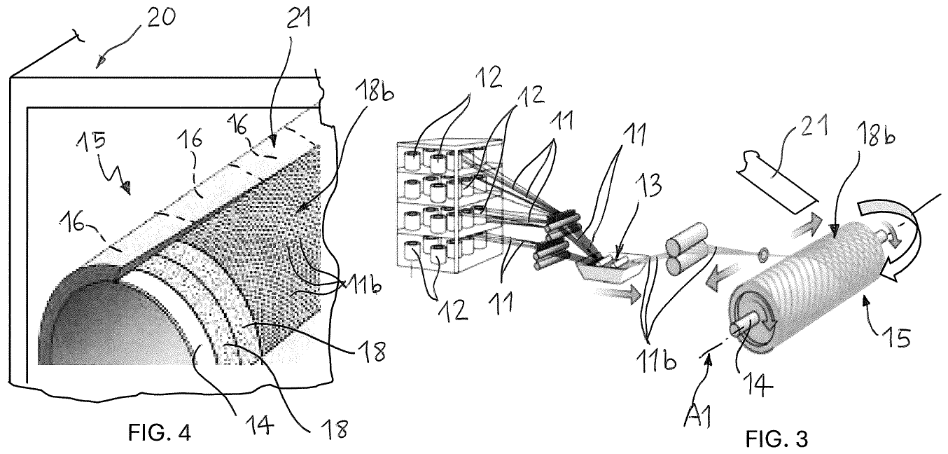

The annular body 7 is made of a fiber-reinforced synthetic plastic material and in a preferred embodiments of the present disclosure may be obtained by a method known in the art as continuous filament winding, schematically shown in a non-limitative manner in FIG. 3, merely for illustrative purposes and for a better understanding of the disclosure.

With reference to FIG. 3, in a CFW production method a plurality of reinforcing fibers 11 are unwound in known manner from spools 12, are impregnated in known manner with a synthetic resin/material, 13 and then the impregnated reinforcing fibers 11b are wound around a mandrel tool or mandrel 14 with a prefixed inclination with respect to the axis of symmetry A1 of mandrel 14, up to obtain a preform tube 15 (FIGS. 3 and 4).

In alternative, pre-peg (pre-impregnated) fibers or sheets of neatly ordered fibers may be used to obtain the preform tube 15, e.g., according to any fiber placement method known in the art, in the end still obtaining a preform tube 15, in this case made up of a number of sheet or mats of polymer impregnated fibers, strictly wound onto one another and around the mandrel or mandrel tool 14, in each sheet or mat the polymer impregnated fibers being neatly arranged according to a predetermined pattern.

In any case, the final preform tube 15 (FIG. 4) comprises a plurality of layers 18 of polymer impregnated fibers 11b stacked onto each other and strictly (i.e., without any radial play) wound around the mandrel/mandrel tool 14.

The axis of symmetry A1 of mandrel 14 coincides with the axis of symmetry A of the cages 3 to be obtained and, in case of a CFW process, to the axis of winding of the fibers 11 around the mandrel 14.

To obtain a plurality of annular bodies 7 from a single preform tube 15, the preform tube is cured in any known and suitable manner (e.g. according to FR 3053624 A1) within any known and suitable oven 20 (FIG. 4), in order to polymerize the synthetic plastic material or resin 13 to form a solid matrix, and is thereafter cut (in a manner known in the art and not shown for sake of simplicity) into radially in slices constituted each by an axial segment 16 (FIG. 4) of the preform tube 15 cut away in a radial direction from the preform tube 15, e.g., along the dotted lines (FIG. 4), such as each axial segment 16 of the preform tube 15 has the same axial width/length of a cage 3 to be obtained.

Before or after the cutting step, but generally after the curing step, a plurality of radial holes configured to constitute the pockets or seats 8 are drilled through each axial segment 16 of the preform tube 15 (method step well known in the art and not shown for sake of simplicity).

In alternative, the pockets or seats 8 may be obtained, still in known manner, during the winding step as shown in FIG. 3, by properly arranging the axial position of the fibers 11b and by providing the mandrel 14 with a plurality of radially outstanding pins (not shown) each configured to form a hole corresponding to a pocket or seat 8 in the preform tube 15, directly during its formation.

Accordingly, as shown in FIG. 4, each cured segment 16 comes to constitute, after the cutting step, an annular body 7 (FIG. 2). Each annular body 7, therefore, comprises a plurality of superimposed layers 18 of reinforcing fibers 11 embedded in a synthetic plastic material 13 and arranged with respect to the axis of symmetry A/A1 according to a prefixed pattern.

The preform tube 15 can be formed from a polymerized fiber reinforced thermoset resin or a polymerized thermoplastic resin. In this latter case, the curing step of the preform tube 15 would be no longer strictly necessary, since the thermoplastic powder for impregnating/embedding the fibers could be at least partially polymerized directly on the mandrel 14.

According to a first aspect of the disclosure, and with reference to FIGS. 3 and 4, the preform tube 15 is obtained, preferably by the CFW method shown in FIG. 3, but other known methods of fiber placement may be used, with an outer diameter thereof substantially identical, or very close, to the design outer diameter of the cage 3 to be obtained and then a commercial shrink tape 21 is strictly wound under tension upon the complete outer lateral surface of the radially outermost layer 18 (indicated as 18b in FIGS. 3 and 4) of the preform tube, before the curing step.

Here and herein below, the expression “strictly wound” means a winding without leaving any radial play and carried out such as to expel outside any air possibly trapped between the radially outermost layer 18 of the preform tube 15 and the shrink tape 21.

Accordingly, the present disclosure comprises a method for producing a composite material rolling bearing cage 3 comprising an annular body 7 and a plurality of pockets or seats 8 each configured to house in use a respective rolling body 6 of a rolling bearing 2, the annular body 7 having an axis of symmetry A and a prefixed axial width and the pockets or seats 8 being provided radially throughout the annular body 7, through respective inner and outer cylindrical surfaces 9, 10 of the annular body 7 radially delimiting the same; the method comprising the steps of: a) producing a preform tube 15 made of a synthetic plastic material 13 reinforced with fibers 11 by arranging onto and around a mandrel 14 having an axis of symmetry A1 coinciding with the axis of symmetry A of the rolling bearing cage 3 to be obtained a plurality of layers 18 (FIG. 4) of reinforcing fibers 11b impregnated with/embedded in a synthetic resin material 13; b) curing the preform tube 15 in order to completely polymerize the synthetic resin material 13 to form a synthetic plastic matrix in which the reinforcing fibers 11 are embedded according to a prefixed pattern; c) radially cutting from the cured preform tube 15 a plurality of axial segments 16 thereof, each having an axial width identical to that of the rolling bearing cage 3 to be obtained, each the axial segment 16 of the preform tube 15 having a plurality of pockets or seats 8 provided therethrough and configured to house in use rolling bodies of a rolling bearing; the pocket or seats 8 are obtained during step a) or are drilled in the preform tube 15 after step b).

According to an aspect of the disclosure, the method further comprises the step of winding without radial play and under tension a shrink tape 21 around the preform tube 15, upon a radially outermost layer 18b thereof. In combination with this latter step, the step b) of curing the preform tube 15 is always carried out and without removing the preform tube 15 from the mandrel 14 and by inserting it and the mandrel 14 into an oven 20 of known type, the preform tube 15 being enclosed by the shrink tape 21.

Thereafter, the assembly formed by the mandrel 14, the preform tube 15 and the shrink tape 21 is heated to a polymerization temperature of the synthetic plastic material 13 (FIG. 4). Thereafter, upon completion of the polymerization of the synthetic plastic material 13, the preform tube 15 is cut in radial direction to separate its axial segments 16 from each other, before or after having produced the pockets or seats 8, one row of them through each segment 16 so as the only machining to which the preform tube 15 is subjected in order to obtain the desired rolling bearing cages 3 is the drilling operation to obtain the pockets or seats 8 and the cutting operation to separate the stretches 16, each one of them coming to constitute a rolling bearing cage 3.

In embodiments of the method of the disclosure, the reinforcing fibers 11 are synthetic fibers of a high tensile strength and stiff material and are impregnated by/embedded in a synthetic plastic material 13 having a glass transition temperature of at least 90° C. and preferably of 120° C. In preferred embodiments of the method of the disclosure, the synthetic resin material 13 is an epoxy resin. In embodiments of the method of the disclosure, the reinforcing fibers 11 are selected in the group consisting of: carbon fibers, glass fibers, Kevlar® fibers, any synthetic fiber similar thereto in tensile strength and stiffness.

In some embodiments, the reinforcing fibers may comprise mineral fibers like basalt and quartz fibers and also in ceramic fibers, like Al₂O₃ or SiC fibers and even in metal fibers like steel or aluminum fibers. In some embodiments, the reinforcing fibers may consist in other organic fibers like cotton, cellulose, flax, jute, hemp and sisal fibers.

In preferred embodiments of the method of the disclosure, the preform tube 15 is obtained by a continuous filament winding technique, by winding on the mandrel 14 at least one continuous reinforcing fiber 11 impregnated with the synthetic resin material 13, the synthetic resin material 13 having a glass transition temperature, after curing, of at least 90° C. and preferably 120° C.

In embodiments of the method of the disclosure, the step a) is carried out until the radially outermost layer 18b (FIGS. 3, 4) of the preform tube 15 which is arranged around the mandrel 14 reaches an outer diameter substantially identical to the design outer diameter of the rolling bearing cage 3 to be obtained.

In different embodiments of the method of the disclosure, the step a) is carried out until the radially outermost layer 18b of the preform tube 15 arranged around the mandrel 14 reaches an outer diameter substantially identical to the design outer diameter of the rolling bearing cage 3 to be obtained unless the thickness of the shrink tape 21 wound therearound. In this case, the shrink tape 21 wound therearound may not be removed after competition of step b).

In embodiments of the method of the disclosure, the shrink tape 21 is sensitive to heat. The shrink tape 21 preferably comprises an endless, possibly colored polyester silk wound with solid edges and having a thickness of between 0.15 and 0.22 mm, a tear force between 230 and 900 N and a shrinkage rate in hot air at 160° C. of at least 9%. For example, according to embodiments of the disclosure, a commercial shrink tape 21 marketed by company SinFlex® may be used.

From what described, it is evident that the present disclosure extends to composite material rolling bearing cage 3 comprising an annular body 7 and a plurality of pockets or seats 8 each configured to freely house in use a respective rolling body 6 of a rolling bearing 2, the annular body 7 having an axis of symmetry A and a prefixed axial width and the pockets or seats 8 being provided radially throughout the annular body, through respective inner and outer cylindrical surfaces 9,10 of the annular body 7 radially delimiting the same, the annular body 7 being made of a fiber-reinforced synthetic plastic material comprising a plurality of superimposed layers 18 of reinforcing fibers 11 embedded in a synthetic resin material 13 and arranger with respect to the axis of symmetry A according to a predetermined pattern.

The consolidated (after curing) synthetic plastic material 13 may have a glass transition temperature greater than or equal to 90° C. and preferably greater than or equal to 120° C., the synthetic plastic material 13 may comprise an epoxy resin, and the reinforcing fibers 11 may be selected from the group consisting of: carbon fibers, glass fibers, Kevlar® fibers, mineral fibers like basalt and quartz fibers, ceramic fibers, e.g., Al2O3 or SiC fibers, metal fibers, e.g., steel or aluminum fibers, organic fibers including cotton, cellulose, flax, jute, hemp and sisal fibers, any synthetic, organic or inorganic fiber similar thereto in tensile strength and stiffness.

The reinforcing fibers 11 may be continuous fibers impregnated in the synthetic resin material 13 and wound around the axis of symmetry A according to predetermined winding angles, to form the superimposed layers 18, the continuous fibers of each layer forming with the axis of symmetry A in a plan view an angle corresponding to the winding angle thereto. The rolling bearing cage 3 having been obtained by the method as disclosed herein above has inner and outer cylindrical lateral surfaces 9,10 that do are unmachined and have a smooth finishing.

According to one aspect of the disclosure, the rolling bearing unit 1 in FIG. 1 comprises therefore a rolling bearing, e.g., the rolling bearing 2 or any other model of rolling bearing having a plurality of rolling bodies 6 arranged in a radial space delimited between the inner ring 4 and the outer ring 5 to render them relatively rotatable with low friction, and a rolling bearing cage 3 as described above for retaining the rolling bodies 6 spaced apart. The rolling bearing 2 is preferably of the high precision bearing type, characterized by high speed and/or high load of operation.

Based on this disclosure, additional grinding or turning processes of filament wound epoxy/carbon tubes to achieve required inner and outer cage diameters within requested tolerances can be eliminated or eventually reduced to a minimum, depending on the cases. The number of layers, the type of tape material used, and the orientation of the layer give enough flexibility to reach any diameter with high precision. There is no further need to produce semi-finished preform tubes with higher thickness compared to final cage thickness. Reduction of needed epoxy/carbon tape material leads to waste reduction, cost reduction and carbon footprint reduction. Lower required preform tube thickness leads to reduction of tube hardening oven time and energy and therefore cost reduction. Finally, an overall reduction of total cage production cycle time and total cage manufacturing cost is obtained. All the aims of the disclosure are therefore achieved.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved methods of forming composite bearing cages.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A method for producing a composite material rolling bearing cage comprising:
a) winding around a mandrel a plurality of layers of reinforcing fiber impregnated with or embedded in a synthetic resin material to form a preform tube on the mandrel;
b) after step a), wrapping, without radial play and under tension, a shrink tape around the radially outermost layer of reinforcing fiber of the preform tube,
c) after step b, without removing the shrink tape, inserting the mandrel and preform tube into an oven and curing the preform tube on the mandrel to polymerize the synthetic resin to form a synthetic plastic matrix in which the reinforcing fibers are embedded;
d) radially cutting a plurality of axial segments from the preform tube; and
e) providing a plurality of radial through openings in each of the plurality of axial segments.

2. The method according to claim 1,
wherein the synthetic resin material has a glass transition temperature of at least 90° C.

3. The method according to claim 2,
wherein the synthetic resin material is an epoxy resin.

4. The method according to claim 3,
wherein the reinforcing fiber is selected from the group consisting of: carbon fiber, glass fiber, Kevlar® fiber, basalt fiber, quartz fiber, Al₂O₃ fiber, SiC fiber, steel fiber, aluminum fiber, cotton fiber, cellulose fiber, flax fiber, jute fiber, hemp fiber and sisal fiber.

5. The method according to claim 4,
wherein the winding comprises winding around a mandrel the plurality of layers of reinforcing fiber impregnated with the synthetic resin material.

6. The method according to claim 5,
wherein the shrink tape comprises a polyester silk tape having solid edges, a thickness of between 0.15 and 0.22 mm, a tear force between 230 and 900 N and a shrinkage rate in 160° C. air of at least 9%.

7. A composite material rolling bearing cage produced by the method of claim 6.

8. The method according to claim 1,
wherein the synthetic resin material has a glass transition temperature of at least 120° C.

9. The method according to claim 1,
wherein the synthetic resin material is a thermoplastic powder.

10. The method according to claim 1,
wherein the shrink tape comprises a polyester silk tape having solid edges, a thickness of between 0.15 and 0.22 mm, a tear force between 230 and 900 N and a shrinkage rate in 160° C. air of at least 9%.

11. A composite material rolling bearing cage comprising:
an annular body comprising a plurality of wound layers of reinforcing fibers embedded in a cured synthetic resin and having a plurality of pockets, and
a heat-shrunk layer of heat shrinkable polyester silk tape wound around a radially outermost surface of the annular body.

12. The composite material rolling bearing cage according to claim 11,
wherein the synthetic resin is an epoxy resin, and
wherein the heat shrinkable polyester silk tape has solid edges, a thickness of between 0.15 and 0.22 mm, a tear force between 230 and 900 N and a shrinkage rate in 160° C. air of at least 9%.

13. A rolling bearing comprising:
an outer ring,
an inner ring,
a composite material bearing cage according to claim 12 between the outer ring and the inner ring, and
a plurality of rolling bodies arranged in respective ones of the plurality of pockets.
